(19) United States
(12) Patent Application Publication
(10) Pub. No.: US 2025/0225374 A1
(43) Pub. Date: Jul. 10, 2025

(54) REINFORCED TOTAL VARIATION DISTANCE LOSS FOR MACHINE LEARNING MODELS

(71) Applicant: QUALCOMM Incorporated, San Diego, CA (US)

(72) Inventors: Raghavv GOEL, San Diego, CA (US); Mukul GAGRANI, Milpitas, CA (US); Wonseok JEON, San Diego, CA (US); Mingu LEE, San Diego, CA (US); Christopher LOTT, San Diego, CA (US)

(21) Appl. No.: 18/407,166

(22) Filed: Jan. 8, 2024

(51) Int. Cl. G06N 3/0455; G06N 3/084

(52) U.S. Cl. CPC G06N 3/0455; G06N 3/084

(57) ABSTRACT

Systems and techniques are described herein for training a machine learning (ML) model. For instance, a process can include obtaining, from a teacher ML model, a first prediction based on an input. The process can further include obtaining, from a student ML model, a second prediction based on the input. The process can include determining a loss based on a difference between the second prediction from the first prediction. For instance, the loss can include a variance reduced total variation distance (TVD) loss based on an unbiased gradient estimate of the loss. The process can further include backpropagating the loss through the student ML model to train the student ML model.

### FIELD

The present disclosure generally relates to training machine learning (ML) models. For example, aspects of the present disclosure are related to systems and techniques for providing a reinforced total variation distance loss for ML models.

### BACKGROUND

Large language models (LLMs) are artificial intelligence/machine learning (AI/ML) models that are designed to process textual content to learn to recognize and classify textual elements, such as words, punctuation, phrases, and so forth. The LLMs are further designed to generate text based on the textual content. As an example, an LLM may be trained to perform natural language processing tasks, such as generating, predicting, translating, etc. text. A visual language model (VLM) is a NN that is trained to process visual content (e.g., images) and textual content to generate a text output (e.g., generating, predicting, translating, etc. text).

In some cases, LLMs and VLMs may be implemented using neural networks (NN), such as transformer models. A transformer model may be a type of ML model (e.g., a NN) that includes an encoder and decoder and may be used to tokenize inputs, learn relationships between the tokens, and then generate predictions using the tokens. As implied by the name, LLMs and VLMs can be relatively large models that can be resource intensive to execute. In some cases, techniques to reduce resource use from existing LLM and VLM models (e.g., pretrained LLM and VLM models) while obtaining the predictive capability of these LLM and VLM models may be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, an apparatus for training a machine learning (ML) model is provided. The apparatus includes at least one memory and at least one processor coupled to the at least one memory. The at least one processor is configured to: obtain, from a teacher ML model, a first prediction based on an input; obtain, from a student ML model, a second prediction based on the input; determine a loss based on a difference between the second prediction from the first prediction, wherein the loss comprises a variance reduced total variation distance (TVD) loss based on an unbiased gradient estimate of the loss; and backpropagate the loss through the student ML model to train the student ML model.

As another example, a method for training a machine learning (ML) model is provided. The method includes: obtaining, from a teacher ML model, a first prediction based on an input; obtaining, from a student ML model, a second prediction based on the input; determining a loss based on a difference between the second prediction from the first prediction, wherein the loss comprises a variance reduced total variation distance (TVD) loss based on an unbiased gradient estimate of the loss; and backpropagating the loss through the student ML model to train the student ML model.

In another example, a non-transitory computer-readable medium having stored thereon instructions in provided. The instructions, when executed by at least one processor, cause the at least one processor to: obtain, from a teacher ML model, a first prediction based on an input; obtain, from a student ML model, a second prediction based on the input; determine a loss based on a difference between the second prediction from the first prediction, wherein the loss comprises a variance reduced total variation distance (TVD) loss based on an unbiased gradient estimate of the loss; and backpropagate the loss through the student ML model to train the student ML model.

As another example, an apparatus for training a machine learning (ML) model is provided. The apparatus includes: means for obtaining, from a teacher ML model, a first prediction based on an input; means for obtaining, from a student ML model, a second prediction based on the input; means for determining a loss based on a difference between the second prediction from the first prediction, wherein the loss comprises a variance reduced total variation distance (TVD) loss based on an unbiased gradient estimate of the loss; and means for backpropagating the loss through the student ML model to train the student ML model.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2A illustrates an example of a fully connected neural network;

FIG. 2B illustrates an example of a locally connected neural network;

FIG. 2C illustrates an example of a convolutional neural network (CNN);

FIG. 2D illustrates a detailed example of a deep convolutional network (DCN);

FIG. 3 is a block diagram illustrating an example of a deep convolutional network;

FIG. 4 is a block diagram illustration an example of knowledge distillation, in accordance with aspects of the present disclosure;

FIG. 5 is an example illustrating speculative decoding for token generation, in accordance with aspects of the present disclosure;

FIG. 6 is a flow diagram illustrating a process for training an ML model, in accordance with aspects of the present disclosure; and

FIG. 7 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As noted previously, a large language model (LLM) may be trained to process textual data to perform natural language processing tasks, such as generating, predicting, translating, etc. text. A visual language model (VLM) may be trained to process visual and textual data to generate a text output (e.g., generating, predicting, translating, etc. text).

Knowledge distillation (KD) is a commonly used framework for training a model with ground truth labels from a pre-trained model. The model being trained is usually smaller in size than the pre-trained model. Using KD can case the process of training a smaller model having less representational power. KD also helps in aligning an output of an untrained model with the pre-trained model. Speculative decoding is a technique that can be used to increase efficiency of running generative AI based LLMs on processors (e.g., central processing units (CPUs), neural processing units (NPUs), etc.), where an important task is to align an untrained small model with a larger pre-trained model. The better the alignment of the output of the two models, the better efficiency in running LLMs on a processor (e.g., CPUs, NPUs, etc.). Distillation based training is commonly used for aligning these two models used in speculative decoding.

In some examples, one ML model, referred to as a teacher ML model (e.g., target ML model in speculative decoding) may be used to train another ML model, referred to as a student ML model (e.g., draft ML model in speculative decoding), to generate predictions similar to the teacher ML model. In cases where the teacher-student model output logits are accessible, the output distribution (e.g., prediction distribution) of the teacher ML model may be used as the ground truth for the student ML model. A loss may be calculated representing the difference between a prediction distribution of the student ML and a prediction distribution of the teacher ML model. Commonly used training losses are a form of distance metric on probability distribution space, such as: KL-Divergence (KLD) and Total-variation Distance (TVD). We observed that these losses either lead to instability during training due to the presence of limited precision or do not provide good empirical results when evaluated on generative AI tasks, such as dialogue generation, summarization, and translation. For instance, a TVD loss may be an L₁ norm between two probability distributions. However, the TVD loss may have a binary reward value which may not provide any feedback to the student ML model in cases of 0 reward, potentially making training slower. In some cases, it may be useful to reduce variances for the TVD loss as it has an unbiased gradient estimate which may result in better performance.

Systems, apparatuses, electronic devices, methods (also referred to as processes), and computer-readable media (collectively referred to herein as “systems and techniques”) are described herein for training ML models using a reinforced TVD loss (e.g., variance reduced TVD loss). The reinforced total variation distance loss described herein is based on a relationship between a gradient of the TVD loss and policy-gradient in Reinforcement Learning (RL). RL is an ML paradigm that involves an agent interacting with the environment to maximize the sum of its reward by updating its policy. The policy update step can be based on computing a policy-gradient.

In some cases, a variance reduction technique may be applied to the TVD loss. For instance, the TVD loss gradient is an unbiased gradient estimate, in which case variance reduction techniques from RL can be used to improve a learned policy (e.g., a student ML model, such as a smaller LLM). Advantage normalization is an example of a variance reduction technique that may be applied to the TVD loss. The advantage normalization may include subtracting a mean of the advantage function of the TVD loss and dividing by a standard deviation of the batch. The variance reduced TVD loss may be used for training a student ML model to align with a teacher ML model.

The reinforced TVD loss performs better than traditional TVD in terms of mean and standard-deviation error between untrained and pre-trained model outputs. For example, reinforced TVD loss can allow an ML model to achieve the same or higher average token generation as TVD using fewer model training steps (e.g., in half of the total model training steps), which can be increased after training for same number of optimization steps.

Various aspects of the present disclosure will be described with respect to the figures.

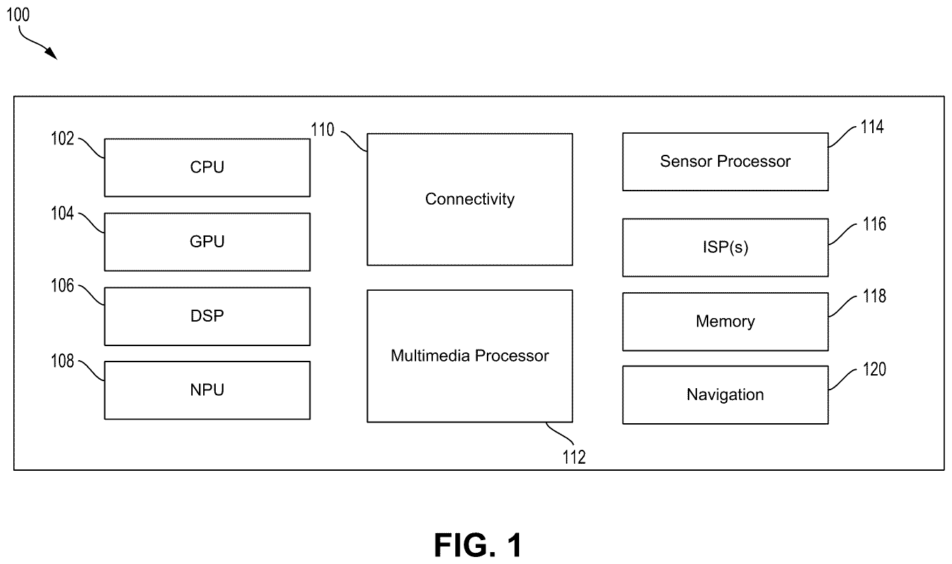

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

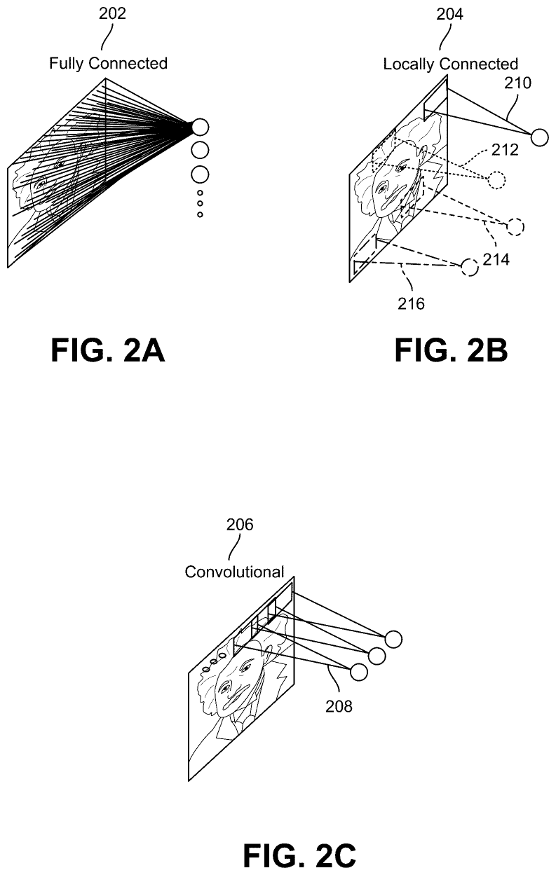

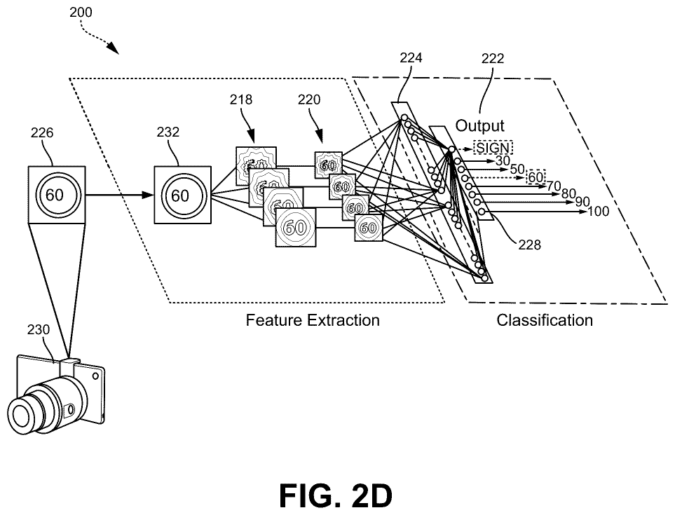

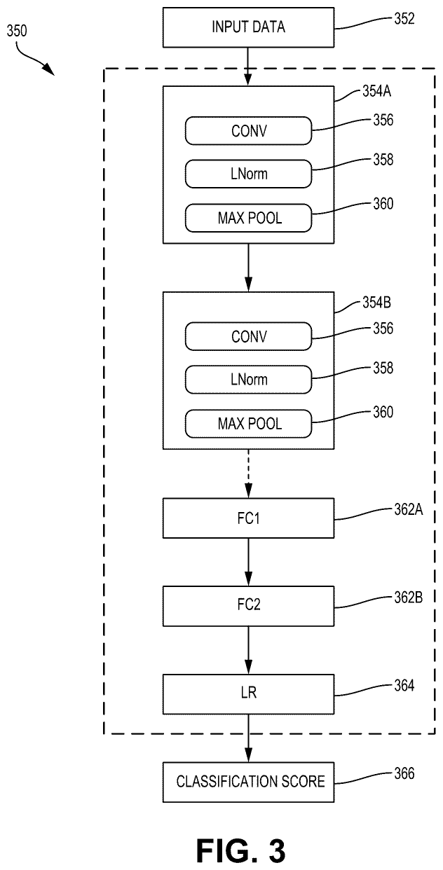

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connect-ed. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decom-pression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system based on SOC 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A Softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. Adjusting the weights in such a manner may be referred to as “back propagation” as it involves a “backward pass” through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and out-put targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

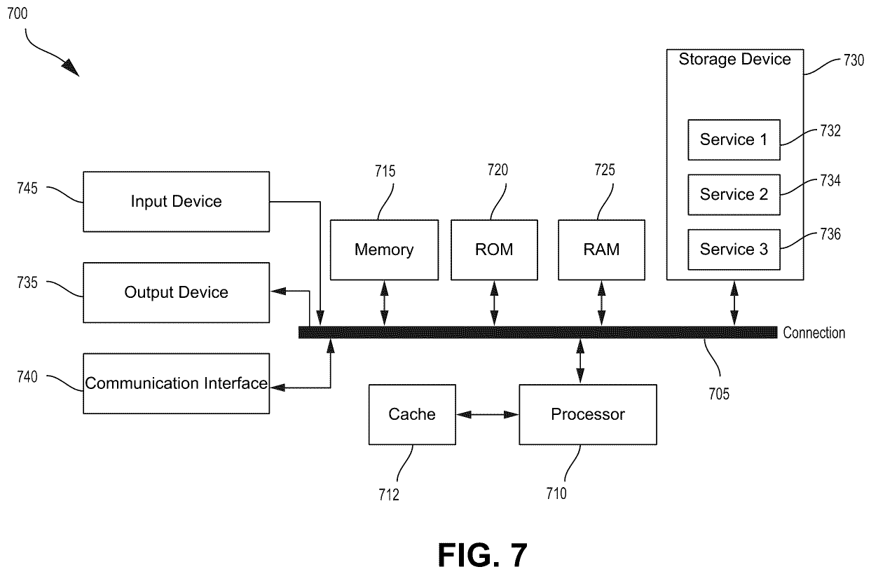

The parallel filter banks, for example, of a deep convolutional network may be loaded on a processor such as a CPU, GPU, NPU, or any other type of processor 1010 discussed with respect to the computing device architecture 700 of FIG. 7 to achieve high performance and low power consumption. In alternative aspects, the parallel filter banks may be loaded on a DSP or an ISP of the computing device architecture 700 of FIG. 7. In addition, the deep convolutional network 350 may access other processing blocks that may be present on the computing device architecture 700 of FIG. 7, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. The set of DCNs may function as feature extractors to identify features in an image. In some cases, feature extractors may be used as a backbone for additional ML network components to perform further operations, such as image segmentation.

In some cases, CNN and/or DCNs may be generalized in the form of a transformer network. A transformer network may extract features from an input sequence and the transformer network may include attention mechanisms that may enable the transformer network to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer network may include a series of feedforward layers whose configurations may change in response to identifying non-linear relationships between the input and output sequences, which may also be referred to as a process of “learning” by the layers. The output of a transformer structure may be obtained by applying a linear transformation to the output of a final attention layer. A transformer structure may be of particular use for tasks that involve sequence modeling, text generation, or other like processing.

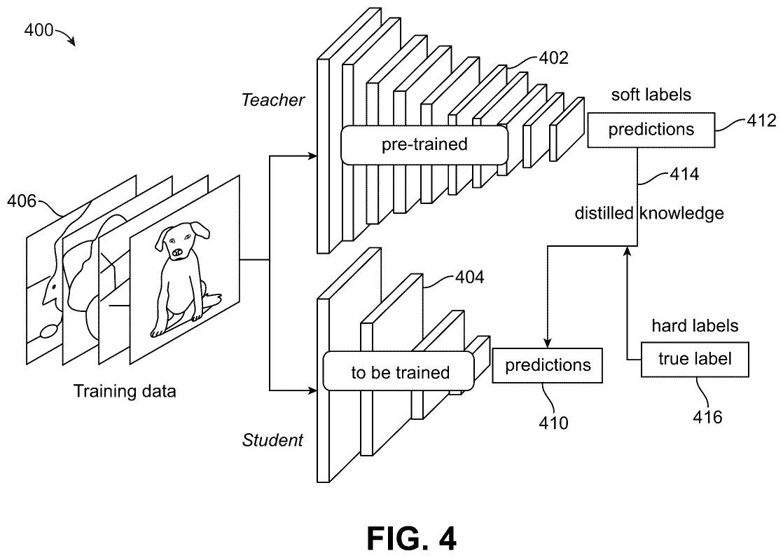

FIG. 4 is a block diagram illustration an example of knowledge distillation 400, in accordance with aspects of the present disclosure. In the knowledge distillation 400, knowledge from a pre-trained teacher ML model 402 (e.g., target ML model) may be used to train a student ML model 404 (e.g., draft ML model) to generate similar predictions (e.g., aligning the ML models) as the teacher ML model 402 given the same input. In some cases, the teacher ML model 402 may be a relatively larger and/or more computationally expensive ML model as compared to the student ML model 404. For example, the teacher ML model 402 may include more layers as compared to the student ML model 404. As the student ML model 404 may be a more lightweight ML model, the student ML model 404 may have a lower representational power as compared to the teacher ML model 402 and the student ML model 404 may learn more relevant information quicker using predictions (e.g., output distributions, such as probability distributions) of the teacher ML model 402 as compared to the ground truth labels alone.

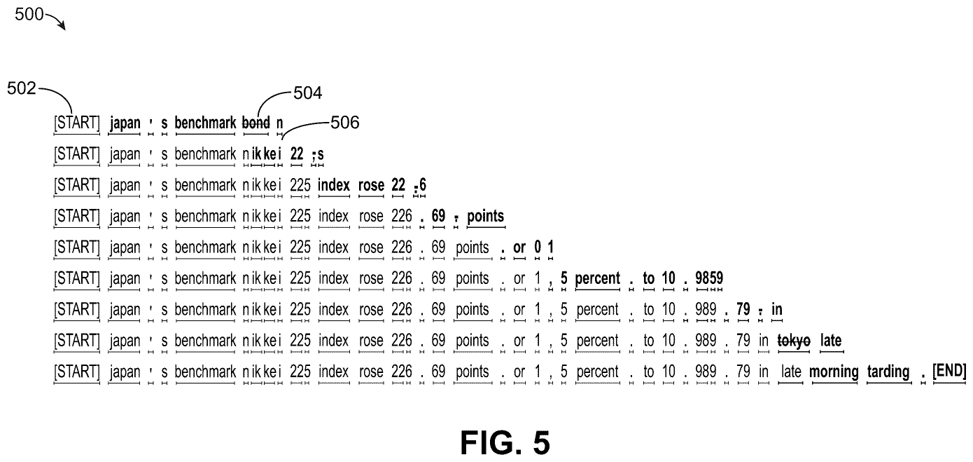

To train the student ML model 404, training data 406 may be passed into both the teacher ML model 402 and the student ML model 404. In some aspects, the training data 406 may include one or more images (e.g., a batch or multiple batches of training images). A student prediction 410 (e.g., output distribution, such as a probability distribution) of the student ML model may be compared 414 against a teacher prediction 412 (e.g., output distribution, such as a probability distribution) of the teacher ML model 402, and a loss may be determined based on a difference between the student prediction 410 and the teacher prediction 412 and backpropagated through the student ML model 404. In some cases, ground truth labels 416 may also be used, for example to calculate the loss for backpropagation. In some cases, knowledge distillation-based training may be used along with speculative decoding-based inference (e.g., as described, but not limited to, FIG. 5) to help speed up certain AI tasks related to LLMs, such as chat, summarization, translation, etc.

As part of a training process, parameters affecting the functioning of the artificial neurons and layers may be adjusted. For example, backpropagation techniques may be used to train an ML model by iteratively adjusting weights or biases of certain artificial neurons associated with errors between a predicted output of the model and a desired output that May be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent-based optimization algorithm and a stochastic gradient descent-based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

FIG. 5 is an example illustrating speculative decoding for token generation 500, in accordance with aspects of the present disclosure. A token may be a component and/or subcomponent of an input to an ML model. For example, tokens for an LLM may be a word or a part (e.g., subset) of a word. As shown in FIG. 5, individually underlined words or portions of words represent individual tokens. Traditional LLMs may output a single token at a time and each generated token may then be reinput to the LLM to generate a next token (e.g., autoregressive).

Speculative decoding may be a technique for accelerating autoregressive models faster by computing tokens in parallel, allowing for an increased number of tokens to be generated per model run. In some cases, speculative decoding may be performed using multiple ML models. As an example, speculative decoding may use two ML models, a larger target ML model (e.g., teacher ML model) and a smaller draft ML model (e.g., student ML model). The draft ML model may be executed sequentially in an autoregressive fashion (e.g., generating one token based on input and reinputting the generated token to generate another token) until a predefined number of tokens are generated. The predefined number of tokens may then be submitted to the target ML model. The target ML model may sample the tokens generated by the draft ML model to determine whether to accept the tokens generated by the draft ML model.

In some cases, tokens generated by the draft ML model may be accepted if a probability of the token generated by (e.g., sampled from) the draft model is less than or equal to a probability of the token being generated by the target model: P_{draft}(x_{sampled})≤q_{target}(x_{sampled}). As shown in a first line 502 of FIG. 5, tokens “Japan,” “‘,” “s,” and “bond” 504 may be generated by the draft ML model. The target ML model may accept all of the tokens except “bond” 504 as failing the acceptance condition. The draft ML model may resample a new token from a modified distribution and generate a new token, “nikkei” 506. Tokens may thus be generated at a higher rate the more closely the draft ML model can align with the target ML model as the draft ML model may run significantly faster than the target ML model. Techniques for improved training of the draft ML model to allow the draft ML to more closely align with the target ML model may be useful.

In some cases, training draft ML models from target ML models may be performed using losses such as a KL-divergence loss or a total variation distance (TVD) loss and these losses may be used to measure a distance between probability distributions of the draft ML model from the probability distributions of the target ML model. For example, an input may be passed into a target ML model to generate a first prediction (e.g., output distribution). The same input may be passed into a draft ML model to generate a second prediction. The first prediction may be compared against the second prediction to generate a loss based on a difference between the second prediction from the first prediction. The loss may then be backpropagated through draft ML model to adjust weights of the draft ML model for training the draft ML model. Backpropagation may be performed by computing a gradient of the loss function for weights of layers (e.g., derivatives per layer) of the draft ML model. However, KL-divergence loss can often result in NaN results (e.g., where the loss exceeds the float limit), and TVD can be relatively slow as TVD attempts to optimize a reinforcement learning policy-gradient like objective with a binary reward value (e.g., 0 or 1). The binary reward value results in reward value of 0 when the probability of a token from draft ML model is less than the probability of the same token from the target ML model. The reward value of 0 does not lead to any updates of the draft ML model.

In some cases, negative value rewards, which a binary reward may not provide, may also be valuable for reinforcement learning. Additionally, variance reduction is not performed as a part of TVD. As the training loss allows the draft ML model to be trained to perform an action (e.g., predicting tokens) for a policy (e.g., the teacher ML model (LLM)) to maximize the sum of rewards (e.g., minimize loss value), a lack of negative value rewards can hinder training. In some cases, an unbiased gradient estimate may allow for modifying the loss values, so that the loss values may include negative loss values. In some cases, including negative reward values can be performed when the loss function includes an unbiased gradient estimate.

To allow TVD to having a wider range of rewards/loss, a TVD with a maximized expected acceptance rate (e.g., optimizing the loss in TVD for speculative decoding) may be expressed as

$${max}_{θ} {E}_{x ∼ p ( x ; θ )} [ min ( 1 , \frac{q ( x )}{p ( x ; θ )} ) ] ,$$

which may be rewritten as

$${max}_{θ} {Σ}_{x} p ( x ; θ ) min ( 1 , \frac{q ( x )}{p ( x ; θ )} ) = {Σ}_{x} min ( p ( x ; θ ) , q ( x ) ) ,$$

where q(x) represent a target distribution, p(x) represent a target distribution, and θ represents a draft ML model. The loss gradient with respect to θ for TVD with a maximized expected acceptance rate can be expressed as Σₓ1_{q(x)>p(x;θ)}∇p(x;θ), where the loss may be expressed as

$${E}_{x ∼ p ( x ; θ )} [ {\underbrace{{1}_{q ( x ) > p ( x ; θ )}}}_{r ( x )} ∇ log p ( x ; θ ) ] ,$$

and where the loss may be expressed as policy-gradient in reinforcement learning).

In some cases, an unbiased gradient estimate with variance reduction may be used to improve policy learning. As an example, advantage normalization may be applied. In advantage normalization, a mean of the advantage function may be subtracted and the divided by the standard deviation of a batch, shifting the rewards. For example, based on the variance, the rewards may be scaled and some rewards may be negative. These negative rewards may indicate to the draft ML model being trained to focus less on those properties. To apply the advantage normalization, the loss function may be reformulated where θ is detached (e.g., where the gradient may not be backpropagated for that term). The reformulated loss function may be expressed as:

$${E}_{x ∼ p ( x ; {θ}_{detached} )} [ {\underbrace{{1}_{q ( x ) > p ( x ; {θ}_{detached} )}}}_{r ( x )} log p ( x ; θ ) ] ,$$

Advantage normalization may be applied, as shown in Equation 1:

$${E}_{x ∼ p ( x ; {θ}_{detached} )} [ \frac{( {1}_{q ( x ) > p ( x ; {θ}_{d e t a c h e d} )} - μ )}{σ} log p ( x ; θ ) ] , \qquad Eq l$$

where μ=mean(r(x)) and σ=var(r(x)). The gradient in Equation 1 may be log p(x; θ), which is scaled by

$$\frac{( {1}_{q ( x ) > p ( x ; {θ}_{d e t a c h e d} )} - μ )}{σ} .$$

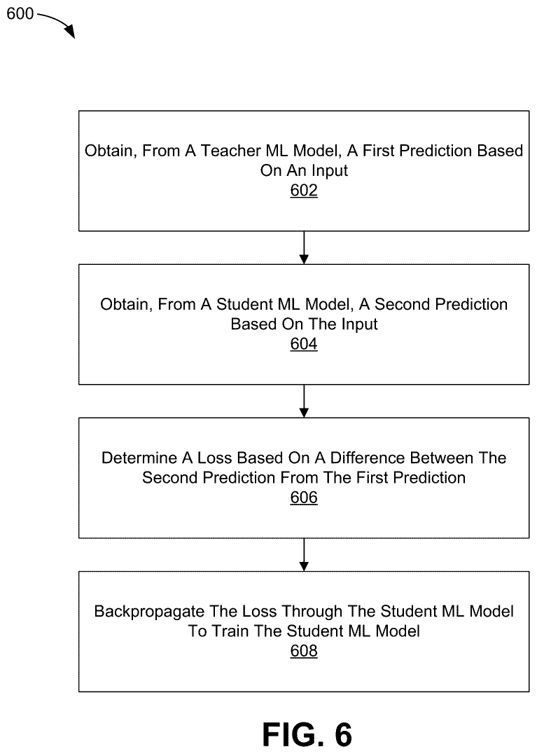

FIG. 6 is a flow diagram illustrating a process 600 for training an ML model, in accordance with aspects of the present disclosure. The process 600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. In some cases, the computing device may be or may include coding device, such as an encoding device, decoding device, or a combined encoding device (or codec). The operations of the process 600 may be implemented as software components that are executed and run on one or more processors (such as CPU 102, GPU 104, DSP 106, NPU 108 of FIG. 1, processor 710 of FIG. 7, etc.).

At block 602, the computing device (or component thereof) may obtain, from a teacher ML model (e.g., pre-trained teacher ML model 402 of FIG. 4.), a first prediction (e.g., an output probability distribution of the teacher ML model, such as the teacher prediction 412 of the pre-trained teacher ML model 402 of FIG. 4.) based on an input (e.g., from training data 406 of FIG. 4). In some cases, the teacher ML model includes more layers (e.g., larger, more computational expensive) than a student ML model. In some cases, the teacher ML model comprises a large language model. In some cases, the input comprises a textual data.

At block 604, the computing device (or component thereof) may obtain, from the student ML model (e.g., student ML model 404 of FIG. 4), a second prediction (e.g., an output probability distribution of the student ML model, such as the student prediction 410 of the student ML model 404 of FIG. 4) based on the input. In some cases, the teacher ML model and student ML model are for use in an autoregressive model (e.g., where generated tokens may be reinput to the model to generate a next token).

At block 606, the computing device (or component thereof) may determine a loss based on a difference between the second prediction from the first prediction. The loss comprises a variance reduced total variation distance (TVD) loss based on an unbiased gradient estimate of the loss. For instance, the TVD loss may exploit the unbiased gradient estimate of the loss. In some cases, the variance reduced TVD loss is based on advantage normalization. In some cases, advantage normalization comprises subtracting a mean of an advantage function and dividing by a standard deviation. In some cases, the variance reduced TVD loss includes negative values.

At block 608, the computing device (or component thereof) may backpropagate the loss through the student ML model to train the student ML model (e.g., to tune weights and/or other parameters of the student ML model).

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 600 and/or other processes described herein may include a processor, microprocessor, micro-computer, or other component of a device that is configured to carry out the steps of the process 600 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 600 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 600 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 illustrates an example computing device architecture 700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 700 are shown in electrical communication with each other using connection 705, such as a bus. The example computing device architecture 700 includes a processing unit (CPU or processor) 710 and computing device connection 705 that couples various computing device components including computing device memory 715, such as read only memory (ROM) 720 and random access memory (RAM) 725, to processor 710.

Computing device architecture 700 can include a cache of high-speed memory connected directly with, in close proximity to, or integrated as part of processor 710. Computing device architecture 700 can copy data from memory 715 and/or the storage device 730 to cache 712 for quick access by processor 710. In this way, the cache can provide a performance boost that avoids processor 710 delays while waiting for data. These and other modules can control or be configured to control processor 710 to perform various actions. Other computing device memory 715 may be available for use as well. Memory 715 can include multiple different types of memory with different performance characteristics. Processor 710 can include any general purpose processor and a hardware or software service, such as service 1 732, service 2 734, and service 3 736 stored in storage device 730, configured to control processor 710 as well as a special-purpose processor where software instructions are incorporated into the processor design. Processor 710 may be a self-contained system, containing multiple cores or processors, a bus, memory controller, cache, etc. A multi-core processor may be symmetric or asymmetric.

To enable user interaction with the computing device architecture 700, input device 745 can represent any number of input mechanisms, such as a microphone for speech, a touch-sensitive screen for gesture or graphical input, keyboard, mouse, motion input, speech and so forth. Output device 735 can also be one or more of a number of output mechanisms known to those of skill in the art, such as a display, projector, television, speaker device, etc. In some instances, multimodal computing devices can enable a user to provide multiple types of input to communicate with computing device architecture 700. Communication interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. Storage device 730 can include services 732, 734, 736 for controlling processor 710. Other hardware or software modules are contemplated. Storage device 730 can be connected to the computing device connection 705. In one aspect, a hardware module that performs a particular function can include the software component stored in a computer-readable medium in connection with the necessary hardware components, such as processor 710, connection 705, output device 735, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology May be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method for training a machine learning (ML) model, comprising: obtaining, from a teacher ML model, a first prediction based on an input; obtaining, from a student ML model, a second prediction based on the input; determining a loss based on a difference between the second prediction from the first prediction, wherein the loss comprises a variance reduced total variation distance (TVD) loss based on an unbiased gradient estimate of the loss; and backpropagating the loss through the student ML model to train the student ML model.

Aspect 2. The method of Aspect 1, wherein the variance reduced TVD loss is based on advantage normalization.

Aspect 3. The method of Aspect 2, wherein advantage normalization comprises subtracting a mean of an advantage function and dividing by a standard deviation.

Aspect 4. The method of any of Aspects 2-3, wherein the variance reduced TVD loss includes negative values.

Aspect 5. The method of any of Aspects 1-4, wherein the teacher ML model includes more layers than the student ML model.

Aspect 6. The method of any of Aspects 1-5, wherein the teacher ML model comprises a large language model.

Aspect 7. The method of any of Aspects 1-6, wherein the input comprises a textual data.

Aspect 8. The method of any of Aspects 1-7, wherein the teacher ML model and student ML model are for use in an autoregressive model.

Aspect 9. An apparatus for training a machine learning (ML) model, comprising: at least one memory; and at least one processor coupled to the at least one memory and configured to: obtain, from a teacher ML model, a first prediction based on an input; obtain, from a student ML model, a second prediction based on the input; determine a loss based on a difference between the second prediction from the first prediction, wherein the loss comprises a variance reduced total variation distance (TVD) loss based on an unbiased gradient estimate of the loss; and backpropagate the loss through the student ML model to train the student ML model.

Aspect 10. The apparatus of Aspect 9, wherein the variance reduced TVD loss is based on advantage normalization.

Aspect 11. The apparatus of Aspect 10, wherein advantage normalization comprises subtracting a mean of an advantage function and dividing by a standard deviation.

Aspect 12. The apparatus of any of Aspects 10-11, wherein the variance reduced TVD loss includes negative values.

Aspect 13. The apparatus of any of Aspects 9-12, wherein the teacher ML model includes more layers than the student ML model.

Aspect 14. The apparatus of any of Aspects 9-13, wherein the teacher ML model comprises a large language model.

Aspect 15. The apparatus of any of Aspects 9-14, wherein the input comprises a textual data.

Aspect 16. The apparatus of any of Aspects 9-15, wherein the teacher ML model and student ML model are for use in an autoregressive model.

Aspect 17. A non-transitory computer-readable medium having stored thereon instructions that, when executed by at least one processor, cause the at least one processor to: obtain, from a teacher ML model, a first prediction based on an input; obtain, from a student ML model, a second prediction based on the input; determine a loss based on a difference between the second prediction from the first prediction, wherein the loss comprises a variance reduced total variation distance (TVD) loss based on an unbiased gradient estimate of the loss; and backpropagate the loss through the student ML model to train the student ML model.

Aspect 18. The non-transitory computer-readable medium of Aspect 17, wherein the variance reduced TVD loss is based on advantage normalization.

Aspect 19. The non-transitory computer-readable medium of Aspect 18, wherein advantage normalization comprises subtracting a mean of an advantage function and dividing by a standard deviation.

Aspect 20. The non-transitory computer-readable medium of any of Aspects 18-19, wherein the variance reduced TVD loss includes negative values.

Aspect 21. The non-transitory computer-readable medium of any of Aspects 17-20, wherein the teacher ML model includes more layers than the student ML model.

Aspect 22. The non-transitory computer-readable medium of any of Aspects 17-21, wherein the teacher ML model comprises a large language model.

Aspect 23. The non-transitory computer-readable medium of any of Aspects 17-22, wherein the input comprises a textual data.

Aspect 24. The non-transitory computer-readable medium of any of Aspects 17-23, wherein the teacher ML model and student ML model are for use in an autoregressive model.

Aspect 25. An apparatus for training a machine learning (ML) model, comprising: means for obtaining, from a teacher ML model, a first prediction based on an input; means for obtaining, from a student ML model, a second prediction based on the input; means for determining a loss based on a difference between the second prediction from the first prediction, wherein the loss comprises a variance reduced total variation distance (TVD) loss based on an unbiased gradient estimate of the loss; and means for backpropagating the loss through the student ML model to train the student ML model.

Aspect 26. The apparatus of Aspect 25, wherein the variance reduced TVD loss is based on advantage normalization.

Aspect 27. The apparatus of Aspect 26, wherein advantage normalization comprises subtracting a mean of an advantage function and dividing by a standard deviation.

Aspect 28. The apparatus of any of Aspects 26-27, wherein the variance reduced TVD loss includes negative values.

Aspect 29. The apparatus of any of Aspects 25-28, wherein the teacher ML model includes more layers than the student ML model.

Aspect 30. The apparatus of any of Aspects 25-29, wherein the teacher ML model comprises a large language model.

Aspect 31. The apparatus of any of Aspects 25-30, wherein the input comprises a textual data.

Aspect 32. The apparatus of any of Aspects 25-31, wherein the teacher ML model and student ML model are for use in an autoregressive model.

What is claimed is:

1. A method for training a machine learning (ML) model, comprising:
obtaining, from a teacher ML model, a first prediction based on an input;
obtaining, from a student ML model, a second prediction based on the input;
determining a loss based on a difference between the second prediction from the first prediction, wherein the loss comprises a variance reduced total variation distance (TVD) loss based on an unbiased gradient estimate of the loss; and
backpropagating the loss through the student ML model to train the student ML model.

2. The method of claim 1, wherein the variance reduced TVD loss is based on advantage normalization.

3. The method of claim 2, wherein advantage normalization comprises subtracting a mean of an advantage function and dividing by a standard deviation.

4. The method of claim 2, wherein the variance reduced TVD loss includes negative values.

5. The method of claim 1, wherein the teacher ML model includes more layers than the student ML model.

6. The method of claim 1, wherein the teacher ML model comprises a large language model.

7. The method of claim 1, wherein the input comprises a textual data.

8. The method of claim 1, wherein the teacher ML model and student ML model are for use in an autoregressive model.

9. An apparatus for training a machine learning (ML) model, comprising:
at least one memory; and
at least one processor coupled to the at least one memory and configured to:
obtain, from a teacher ML model, a first prediction based on an input;
obtain, from a student ML model, a second prediction based on the input;
determine a loss based on a difference between the second prediction from the first prediction, wherein the loss comprises a variance reduced total variation distance (TVD) loss based on an unbiased gradient estimate of the loss; and
backpropagate the loss through the student ML model to train the student ML model.

10. The apparatus of claim 9, wherein the variance reduced TVD loss is based on advantage normalization.

11. The apparatus of claim 10, wherein advantage normalization comprises subtracting a mean of an advantage function and dividing by a standard deviation.

12. The apparatus of claim 10, wherein the variance reduced TVD loss includes negative values.

13. The apparatus of claim 9, wherein the teacher ML model includes more layers than the student ML model.

14. The apparatus of claim 9, wherein the teacher ML model comprises a large language model.

15. The apparatus of claim 9, wherein the input comprises a textual data.

16. The apparatus of claim 9, wherein the teacher ML model and student ML model are for use in an autoregressive model.

17. A non-transitory computer-readable medium having stored thereon instructions that, when executed by at least one processor, cause the at least one processor to:
obtain, from a teacher ML model, a first prediction based on an input;
obtain, from a student ML model, a second prediction based on the input;
determine a loss based on a difference between the second prediction from the first prediction, wherein the loss comprises a variance reduced total variation distance (TVD) loss based on an unbiased gradient estimate of the loss; and
backpropagate the loss through the student ML model to train the student ML model.

18. The non-transitory computer-readable medium of claim 17, wherein the variance reduced TVD loss is based on advantage normalization.

19. An apparatus for training a machine learning (ML) model, comprising:
means for obtaining, from a teacher ML model, a first prediction based on an input;
means for obtaining, from a student ML model, a second prediction based on the input;
means for determining a loss based on a difference between the second prediction from the first prediction, wherein the loss comprises a variance reduced total variation distance (TVD) loss based on an unbiased gradient estimate of the loss; and
means for backpropagating the loss through the student ML model to train the student ML model.

20. The apparatus of claim 19, wherein the variance reduced TVD loss is based on advantage normalization.
